(19) United States
(12) Patent Application Publication
(10) Pub. No.: US 2016/0070059 A1
(43) Pub. Date: Mar. 10, 2016

(54) RANDOM AIR LINE ROD

(71) Applicant: CORNING INCORPORATED, Corning, NY (US)

(72) Inventors: Minghan Chen, Horseheads, NY (US); Ming-jun Li, Horseheads, NY (US)

(73) Assignee: Corning Incorporated, Corning, NY (US)

(21) Appl. No.: 14/787,628

(22) PCT Filed: Apr. 30, 2014
(86) PCT No.: PCT/US14/36078

§ 371 Date: Oct. 28, 2015

Related U.S. Application Data
(60) Provisional application No. 61/818,449, filed on May 1, 2013.

(51) Int. Cl. G02B 6/02; C03B 37/15; G02B 6/032

(52) U.S. Cl. CPC G02B 6/02314; G02B 6/032; C03B 37/15

(57) ABSTRACT

A rod comprises an optically transmissive body having a length and a cross-section transverse to the length, with a maximum dimension along the cross-section that is from about 500 um to up to 10 cm, the optically transmissive body having air-filled lines, voids, or gas-filled lines that are distributed in a disordered manner over at least a central portion of the cross-section, desirably over the entire cross-section, whereby light launched into the body is confined in a direction transverse to the length of the body and is propagated along the length of the body.

### CROSS-REFERENCE TO RELATED APPLICATIONS

This application claims the benefit of priority under 35 U.S.C. §119 of U.S. Provisional Application Ser. No. 61/818,449 filed on May 1, 2013, the content of which is relied upon and incorporated herein by reference in its entirety.

### FIELD

The disclosed embodiments pertain to the field of rods having optically transmissive bodies, particularly to rods having optically transmissive bodies capable of transmitting images from one plane to another.

### BACKGROUND

Transport of waves through a medium can be severely suppressed and even halted by interference and multiple scattering from random impurities which can give rise to strong (or “Anderson”) localization. The theory behind the process was originally developed relative to matter waves (for electrons in disordered atomic crystals), but it can be directly extended to microwaves, acoustic waves and even matter waves in Bose-Einstein condensate, as well as to electromagnetic waves or light.

In the case of light, random scattering media and disordered lattices have attracted considerable experimental interest as promising model systems for testing localization concepts. One proposed technique to produce multiple scattering is to induce slight amounts of disorder in photonic crystals. In an ideal photonic crystal the light propagation is described by Bloch modes. Breaking the symmetry of such structures leads to multiple scattering of light. The interference of the multiply scattered light can lead to the formation of Anderson-localized modes in a restricted frequency range close to the photonic crystal band gap.

Transverse Anderson localization has also been used as the wave guiding mechanism in optical fibers with random transverse refractive index profiles. Through experiments and numerical simulations, research has shown that the transverse localization can result in an effective propagating beam diameter that is comparable to that of a typical index-guiding optical fiber.

### SUMMARY

The disclosed embodiments include a rod comprising an optically transmissive body having a length and a cross-section transverse to the length, with a maximum dimension along the cross-section that is from 500 um to up to 10 cm, the optically transmissive body having air-filled lines, voids, or gas-filled lines that are distributed in a disordered manner over at least a central portion of the cross section, desirably over the entire cross-section, whereby light launched into the body is confined in a direction transverse to the length of the body and is propagated along the length of the body. The optically transmissive body is desirably comprised of glass and desirably has a substantially circular or oval cross-sectional shape, but may have other shapes as well. The optically transmissive body desirably has a maximum dimension along the cross-section that is from 500 um to up to 10 cm, and the various air-filled lines, voids, or gas-filled lines have diameters, and said diameters are desirably in the range of about 20 nanometers up to 10 microns.

While not being bound by any particular theory, it is believed that the imaging elements disclosed herein may utilize Anderson localization or strong localization, and do not rely on total internal reflection.

The foregoing general description and the following detailed description represent specific embodiments, and are intended to provide an overview or framework for understanding the nature and character of the claims.

### BRIEF DESCRIPTION OF THE DRAWINGS

FIG. 1 is a schematic cross section of a rod with random air lines or random voids, or random gas-filled lines.

FIG. 2 is a digital cross-sectional image of a fabricated random-air-line photonic crystal glass rod.

FIG. 3 is a digital image of the cross section of FIG. 2, taken at higher magnification.

FIGS. 4A and 4B are schematic diagrams comparing the calculated path of light propagation in a regular glass rod and the experimentally detected path of light propagation in a fabricated random-air-line photonic crystal glass rod.

FIG. 5 is a schematic diagram of a test the basic imaging functionality of an embodiment of a rod according to the present disclosure.

FIGS. 6A and 6B are two representations of an image obtained from the test of FIG. 5.

### DETAILED DESCRIPTION

The various rod embodiments disclosed herein rely on a mechanism involving scattering in cross-sectionally disordered structures to confine light to a region of the rod and enable propagation along the length of the rod.

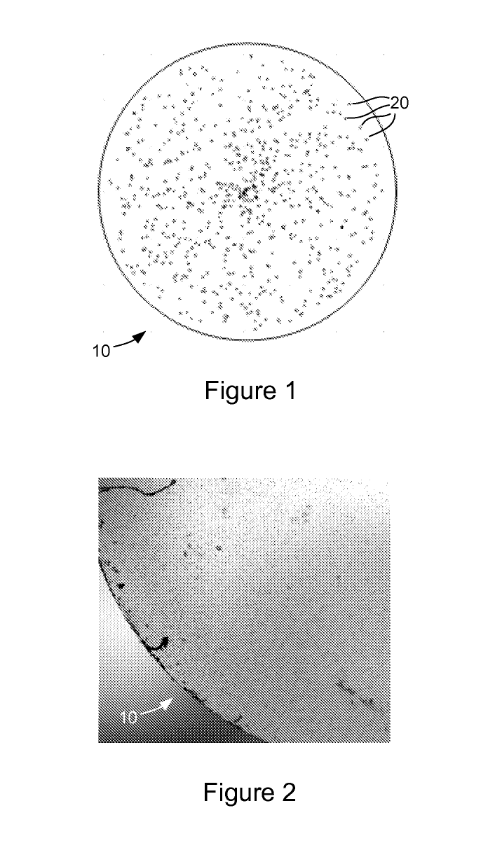

A cross section of a rod 10 (desirably formed of glass) with random air lines (or random voids, or random gas-filled lines) 20 is shown schematically in FIG. 1. As may be seen in the figure, the rod 10 contains randomly distributed air lines (or voids, or gas-filled lines) 20, through the whole glass cross section of the rod 10. This is the currently preferred embodiment, although in one alternative, only a central portion of the rod may contain the contains randomly distributed air lines (or voids, or gas-filled lines) 20. The diameters of the various random, filled lines (or voids) 20 are desirably in the range of a few tens of nanometers to a few micrometers, such as from about 20 nanometers to 10 micrometers, although expected manufacturing variation may produce some outliers. The air lines (or voids, or gas-filled lines) 20 have elongated shapes, hence the term “lines” 20. They are also randomly distributed along the rod 10. The length of the lines 20 is in the range of a few microns to a few millimeters each, but collectively they extend along the entire length of the rod. The lines 20 can be filled with air, or other gases such as N₂, O₂, CO₂, Kr₂, SO₂, and so forth. The fill fraction of the lines within the rod is between 0.5 to 50%, desirably from 0.2 to 20%. The process for making the random line structures is not an aspect of the present disclosure, and may desirably be performed as disclosed in U.S. Pat. No. 7,450,806, U.S. Pat. No. 7,921,675, and U.S. Pat. No. 8,020,410, each of which are expressly incorporated herein by reference for purposes of US law. The diameter of the rod 10 can be from 500 um to a few cm, such as 10 cm. The length of the rod 10 can be from a few millimeters to a few centimeters or even more, depending on the application. The rod may be formed as a single piece according to the methods disclosed in the referenced patents, or, particularly for larger diameters rods, may be formed by fusing multiple fibers or rods first formed by such methods.

The confinement of waves in random structures was disclosed by Anderson, “Absence of diffusion in certain random lattices,” Phys. Rev. 109, 1492-1505 (1958). It is suggested by Anderson that localization of electrons in disordered materials may occur due to a quantum mechanical interference of randomly scattered electrons. While not being bound to any particular theory, the various embodiments disclosed herein are believed to employ mechanisms analogous to those involving localization of electrons in disordered materials in order to confine light, preventing propagation in the direction of high disorder (high spatial frequency disorder) (the cross-sectional direction of the rod),′ the low or lower disorder (low spatial frequency disorder) (the direction along the length of the rod 10, or the direction of the lines 20).

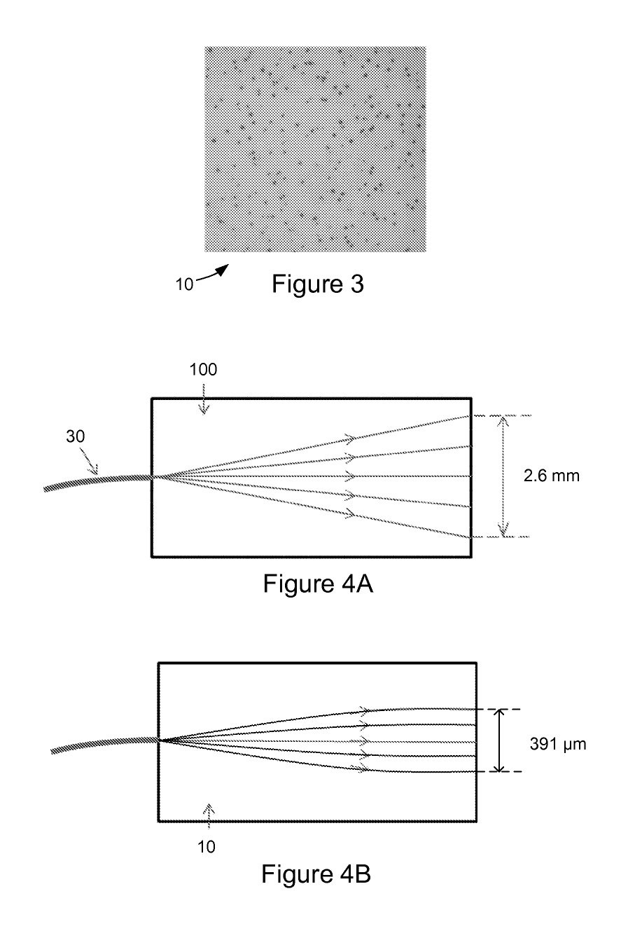

FIG. 2 shows a cross-sectional digital image of a fabricated random-air-line glass rod with a diameter of 4.66 mm, taken with 2.5× objective. The air lines, which are the black dots in the figure, are distributed randomly across the rod cross-section, as seen from the portion of the rod cross-section visible in the figure. FIG. 3 shows a portion of the cross section of FIG. 2, taken with a 40× objective. Average airline diameter in this instance is 1.20±0.53 μm.

FIGS. 4A and 4B are schematic diagrams comparing the calculated path of light propagation in a regular glass rod 100 (FIG. 4A) and the experimentally detected path of light propagation in a fabricated random-air-line photonic crystal glass rod 10 (FIG. 4B) Regarding FIG. 4B, A single mode fiber 30 with 0.14 NA was used to launch a laser beam at one end of the rod 10. At the other end of the rod 10 (total length 14.1 mm), a near field image was taken and the mode field diameter at full width half maximum (FWHM) was measured at 391 μm. In comparison, regarding FIG. 4A, the beam diameter at the exit side of the rod 100 was calculated using ray tracing software, assuming a beam propagating from the fiber 30 through a regular glass rod 100 of length 14.1 mm. The calculated beam width at the exit side of the rod 100 was 2.6 mm, or about 7 times larger than that in the random-air-line rod 10 (the figures are not to scale). This gives good indication of a photon-based Anderson localization effect within the rod 10.

Experiment has also shown that light launched at different positions across the rod cross-section can propagate independently. Accordingly, it is proposed to use the rod as an imaging lens. Due to its miniaturized size, it may be especially appropriate for miniaturized endoscope imaging applications. Traditional micro-optics lens or gradient index lens based imaging system requires either precise optical fabrication (such as precise pitch length in gradient index lens or curvatures in conventional convex, concave lens) or precise alignment. However, for the disclosed rod with random air lines, this is not a problem. It localizes the light from one end surface to the other end surface without any special requirement for the pitch or length of the rod. Both surfaces of the rod are flat, which makes manufacturing easy.

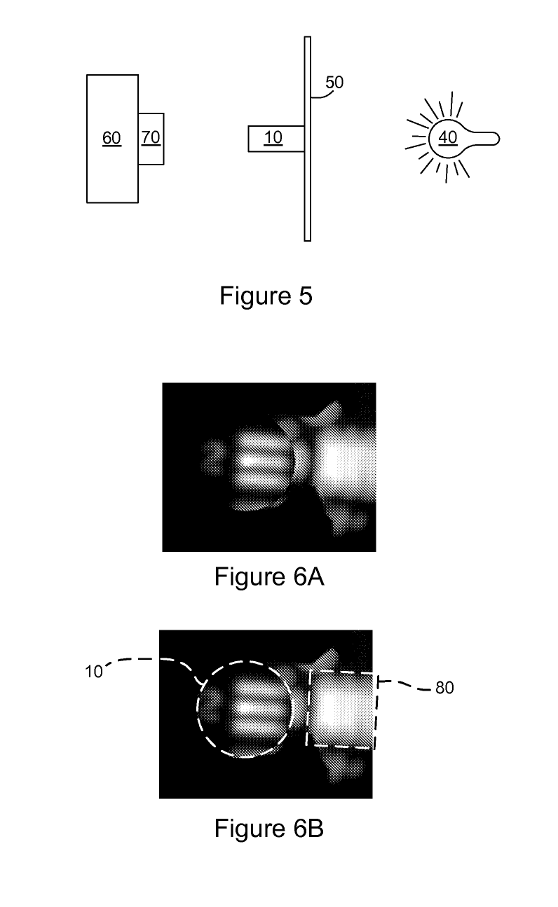

To test the basic imaging functionality of the rod, an experiment was performed according to the basic schematic setup diagramed in FIG. 5. An incoherent white light source 40 illuminates a stencil target 50 which touches a glass rod 10 with random air lines, having a length of about 14 mm. A CCD camera 60 with microscope objective 70 was used to take the near field images which are focused on the opposite end surface of the rod 10, away from the stencil target 50. An image obtained from this test is shown in FIGS. 6A (without reference indicators) and 6B (with reference indicators). As seen in FIGS. 6A and 6B, the end of the rod 10 produces a replication of the three-line target stencil pattern, while a neighboring three-line pattern 80 on the stencil is not reproduced at the plane of the end of the rod 10, and is thus very out of focus and barely distinguishable in the image. Thus it may be seen that the rod 10 is effective to optically transmit or transfer an image from one plane to another, without any additional optical components.

The foregoing description provides exemplary embodiments to facilitate an understanding of the nature and character of the claims. It will be apparent to those skilled in the art the various modifications to these embodiments can be made without departing from the spirit and scope of the appending claims.

1. A rod comprising:
an optically transmissive body having a length and a cross-section transverse to the length with a maximum dimension along the cross-section that is from 500 μm to up to 10 cm, the optically transmissive body having air-filled lines, voids, or gas-filled lines or voids distributed in a disordered manner over at least a central portion of the cross-sectional area of the body and collectively extending along the entire length of the body, whereby light launched into the body within id central portion of the body is confined in a direction transverse to the length of the body and is propagated along the length of the body.

2. The rod according to claim 1 wherein the optically transmissive body has air-filled lines, voids, or gas-filled lines that are distributed in a disordered manner over the entire cross-section of the body, whereby light launched into the body is confined in a direction transverse to the length of the body and is propagated along the length of the body.

3. A rod according to claim 1, wherein the optically transmissive body comprises glass.

4. A rod according to claim 1, wherein the optically transmissive body has a substantially circular or oval cross-sectional shape.

5. A rod according to claim 1, in which the various air-filled lines, voids, or gas-filled lines have diameters, and said diameters are in the range of about 20 nanometers up to 10 microns.

6. A method of forming a rod comprising an optically transmissive body having a length and a cross-section transverse to the length with a maximum dimension along the cross-section that is from 500 μm to up to 10 cm, the optically transmissive body having air-filled lines, voids, or gas-filled lines or voids distributed in a disordered manner over at least a central portion of the cross-sectional area of the body, the method comprising:
forming a plurality of rods or fibers each having air-filled lines, voids, or gas-filled lines or voids distributed in a disordered manner across its respective cross-sectional area; and
fusing the plurality of rods or fibers to form a single optically transmissive body having a cross-section with a maximum dimension along the cross-section that is from 500 μm to up to 10 cm.

7. A method of transmitting an image, the method comprising:
positioning an optically transmissive body, the body having a length and a cross-section transverse to the length with a maximum dimension along the cross-section that is from 500 μm to up to 10 cm, the optically transmissive body having air-filled lines, voids, or gas-filled lines or voids distributed in a disordered manner over at least a central portion of the cross-sectional area of the body and collectively extending along the entire length of the body, the body having first and second ends in the length direction, such that the second end of the body is at a position at which an image is to be received; and
providing an image at the first end of said body.
